(19) United States
(12) Patent Application Publication
(10) Pub. No.: US 2005/0018087 A1
(43) Pub. Date: Jan. 27, 2005

(54) Apparatus and method for detecting a 2:2 pull-down sequence

(75) Inventor: Young-ho Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/893,318

(22) Filed: Jul. 19, 2004

(30) Foreign Application Priority Data
Jul. 21, 2003 (KR) 2003-49907

(51) Int. Cl. G03G 15/09; H04N 9/64

(52) U.S. Cl. 348/700; 348/701

(57) ABSTRACT

An apparatus and method for detecting a 2:2 pull-down sequence, which can accurately detect the 2:2 pull-down sequence is provided. The apparatus includes a main detection unit for calculating a summed absolute difference (SAD) between sequential fields with respect to an input image signal and detecting a 2:2 pull-down image based on the SADs, a sub-detection unit for calculating an absolute change amount between the SADs and detecting the 2:2 pull-down image based on the absolute change amounts, a still image judgment unit for judging whether the input image signal is a still image, and a 2:2 pull-down sequence decision unit for deciding whether the input image signal is the 2:2 pull-down sequence. The apparatus can accurately detect the 2:2 pull-down image by adaptively coping with the changed picture even in the case of much noise.

### CROSS-REFERENCE TO RELATED APPLICATION

This application claims the benefit of Korean Patent Application No. 2003-49907, dated Jul. 21, 2003, in the Korean Intellectual Property Office, the disclosure of which is incorporated herein by reference.

### BACKGROUND OF THE INVENTION

1. Field of the Invention

The present invention relates to an apparatus and method for detecting a 2:2 pull-down sequence, and more particularly, to an apparatus and method for detecting a 2:2 pull-down sequence, which can accurately restore an input image signal by detecting whether the input image signal is a 2:2 pull-down image sequence.

2. Description of the Related Art

Human eyes feel a continuous image if 16 or more sheets of pictures per second appear. That is, in an image in motion, 16 sheets of pictures per second correspond to a minimum sampling frequency (i.e., Nyquist frequency) for sampling a signal with information preserved. In consideration of this, an image for a movie is processed at a speed of 24 sheets of pictures per second, and an image for a television (TV) is processed at a speed of 25 or 30 sheets of pictures per second.

Movies use a progressive system that instantaneously stores every picture in a film and progressively projects the pictures on a screen. In the TV, since an image is basically transmitted over the air, each picture is filmed and transmitted through scanning of several hundreds of scanning lines, and then displayed on a screen of a Braun tube by scanning. In the NTSC (National Television System Committee) color TV system adopted in the United States, Japan, Korea, etc., 30 sheets of pictures, each of which is composed of 525 scanning lines, per second are transmitted, and in the PAL (Phase Alternation by Line) system or SECAM (Sequential Couleur a Memoire) system, 25 sheets of pictures, each of which is composed of 625 scanning lines, per second are transmitted.

Also, the TV uses an interlaced scanning method which divides one picture (i.e., frame) into two fields and alternately scans the two fields in order to effectively present a moving image using limited scanning lines. At this time, the divided fields are called top and bottom fields, odd and even fields, upper and lower fields, etc. Accordingly, the NTSC system processes 60 fields of image per second, and the PAL or SECAM system processes 50 fields of image per second.

When a movie is televised through a TV, every sheet of movie films is transmitted through a converter called a telecine (which is a compound word of a television and a cinema). In the case of transmitting the movie through the PAL or SECAM TV system, 50 fields should be obtained from 25 pictures (i.e., frames), that is, two fields should be obtained with respect to one frame. This method of scanning two fields with respect to the respective frame is called a “2:2 pull-down” system.

The PAL or SECAM TV should perform the 2:2 pull-down work in a reverse manner in order to restore the respective transmitted fields to the progressive system. The most important thing in such a de-interlacing work is to accurately recognize the 2:2 pull-down sequence.

### SUMMARY OF THE INVENTION

An aspect of the invention is to solve at least the above-identified problems and/or disadvantages and to provide at least the advantages described hereinafter.

Another aspect of the present invention is to provide an apparatus and method for detecting a 2:2 pull-down sequence, which can accurately recognize the 2:2 pull-down sequence for a de-interlacing work.

To achieve the above aspects and/or other features of the present invention, there is provided an apparatus for detecting a 2:2 pull-down sequence, comprising a main detection unit for calculating a summed absolute difference (SAD) between sequential fields with respect to an input image signal and detecting a 2:2 pull-down image based on the calculated SADs, a sub-detection unit for calculating an absolute change amount between the calculated SADs and detecting the 2:2 pull-down image based on the absolute change amounts, a still image judgment unit for judging whether the input image signal is a still image based on the calculated SADs and the absolute change amounts, and a 2:2 pull-down sequence decision unit for deciding whether the input image signal is the 2:2 pull-down sequence by combining results of detecting the 2:2 pull-down image by the main detection unit and by the sub-detection unit and a result of judging whether the image signal is the still image by the still image judgment unit.

Preferably, the main detection unit includes a SAD calculation unit for calculating the SAD between the sequential fields of the image signal, a SAD storage unit for sequentially storing the calculated SADs, a first threshold value calculation unit for calculating a first threshold value using the stored SADs, a first pattern generation unit for generating patterns of the SADs according to the calculated first threshold value, a first pattern storage unit for sequentially storing the patterns of the SADs generated by the first pattern generation unit, and a first pattern comparison unit for comparing the pattern of the SAD stored in the first pattern storage unit with a predetermined basic pattern of the SAD. The main detection unit detects the 2:2 pull-down image according to a result of comparison by the first pattern comparison unit. Here, it is preferable that the first threshold value calculation unit includes a first minimum value detection unit for detecting a minimum value of the SADs with respect to a specified section of the SADs stored in the SAD storage unit, and a first maximum value detection unit for detecting a maximum value of the SADs with respect to the specified section. The first threshold value calculation unit calculates the first threshold value based on the detected minimum and maximum values. At this time, the first threshold value calculation unit calculates the first threshold value by the following equation.
T1=a×MIN+b×MAX

Here, T1 denotes the first threshold value, a and b are certain values keeping a+b=1, MIN denotes the minimum value of 5 continuous SADs, and MAX denotes the maximum value of the SADs in the specified section.

Also, the sub-detection unit includes an absolute change amount calculation unit for calculating the absolute change amount between the calculated SADs, an absolute change amount storage unit for sequentially storing the absolute change amounts, a second threshold value calculation unit for calculating a second threshold value using the stored absolute change amounts, a second pattern generation unit for generating patterns of the absolute change amounts according to the calculated second threshold value, a second pattern storage unit for sequentially storing the patterns of the absolute change amounts generated by the second pattern generation unit, and a second pattern comparison unit for comparing the pattern of the absolute change amount stored in the second pattern storage unit with a predetermined basic pattern of the absolute change amount. The sub-detection unit detects the 2:2 pull-down image according to a result of comparison by the second pattern comparison unit. Here, it is preferable that the second threshold value calculation unit includes a second minimum value detection unit for detecting a minimum value of the absolute change amounts with respect to a specified section of the absolute change amounts stored in the absolute change amount storage unit, and a second maximum value detection unit for detecting a maximum value of the absolute change amounts with respect to the specified section. The second threshold value calculation unit calculates the second threshold value based on the detected minimum and maximum values. At this time, the second threshold value calculation unit calculates the second threshold value by the following equation.
T2=a′×MIN′+b′×MAX′

Here, T2 denotes the second threshold value, a′ and b′ are certain values keeping a′+b′=1, MIN′ denotes the minimum value of 5 continuous absolute change amounts, and MAX′ denotes the maximum value of the absolute change amounts of the specified section.

Here, the still image judgment unit judges whether the image signal is the still image according to the pattern of the SAD stored in the first pattern storage unit and the pattern of the absolute change amount stored in the second pattern storage unit.

In another aspect of the present invention, there is provided a method for detecting a 2:2 pull-down sequence, comprising a main detection step of calculating a summed absolute difference (SAD) between sequential fields with respect to an input image signal, and detecting a 2:2 pull-down image based on the calculated SADs, a sub-detection step of calculating an absolute change amount between the calculated SADs, and detecting the 2:2 pull-down image based on the absolute change amounts, a step of judging whether the input image signal is a still image based on the calculated SADs and the absolute change amounts, and a step of deciding whether the input image signal is the 2:2 pull-down sequence by combining results of detecting the 2:2 pull-down image by the main detection unit and by the sub-detection unit and a result of judging whether the image signal is the still image.

The apparatus and method as constructed above according to the present invention can accurately detect a 2:2 pull-down image with respect to the input image signal.

### BRIEF DESCRIPTION OF THE DRAWINGS

The above aspects and other advantages of the present invention will become more apparent by describing in detail exemplary embodiments thereof with reference to the attached drawings in which:

FIG. 1 is a view explaining a 2:2 pull-down process;

FIG. 2 is a block diagram schematically illustrating an apparatus for detecting a 2:2 pull-down sequence according to the present invention;

FIG. 3 is a block diagram schematically illustrating a first threshold value calculation unit in FIG. 2;

FIG. 4 is a block diagram schematically illustrating a second threshold value calculation unit in FIG. 2;

FIG. 5 is a view explaining a relation between a SAD pattern storage unit and an absolute change amount storage unit;

FIG. 6 is a flowchart illustrating a method of detecting a 2:2 pull-down image according to the present invention;

FIG. 7 is a flowchart illustrating a process of detecting a 2:2 pull-down image performed by a main detection unit in FIG. 6;

FIG. 8 is a flowchart illustrating a process of detecting a 2:2 pull-down image performed by a sub-detection unit in FIG. 6;

FIG. 9 is a view illustrating SADs and absolute change amounts described in FIG. 6; and

FIG. 10 is a view illustrating an example of the SAD pattern and the absolute change amount pattern.

### DETAILED DESCRIPTION OF THE EXEMPLARY EMBODIMENT

Now, an apparatus and method for detecting a 2:2 pull-down sequence according to an exemplary embodiment of the present invention will be described in detail with reference to the annexed drawings in which like reference numerals refer to like elements.

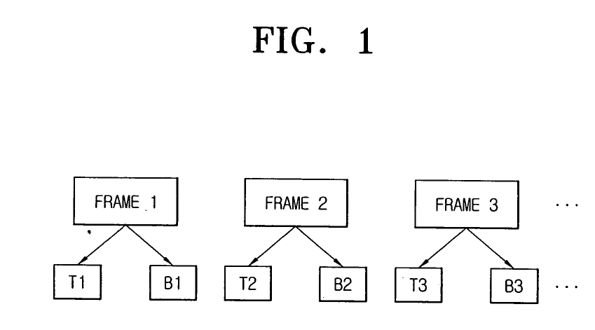

FIG. 1 is a view explaining a 2:2 pull-down process. Referring to FIG. 1, a 2:2 pull-down system scans two fields with respect to one frame. One frame of a movie includes a top field composed of odd lines and a bottom field composed of even lines. In the drawing, T1 denotes a top field of a frame 1, B1 a bottom field of the frame 1, T2 a top field of a frame 2, and B2 a bottom field of the frame 2.

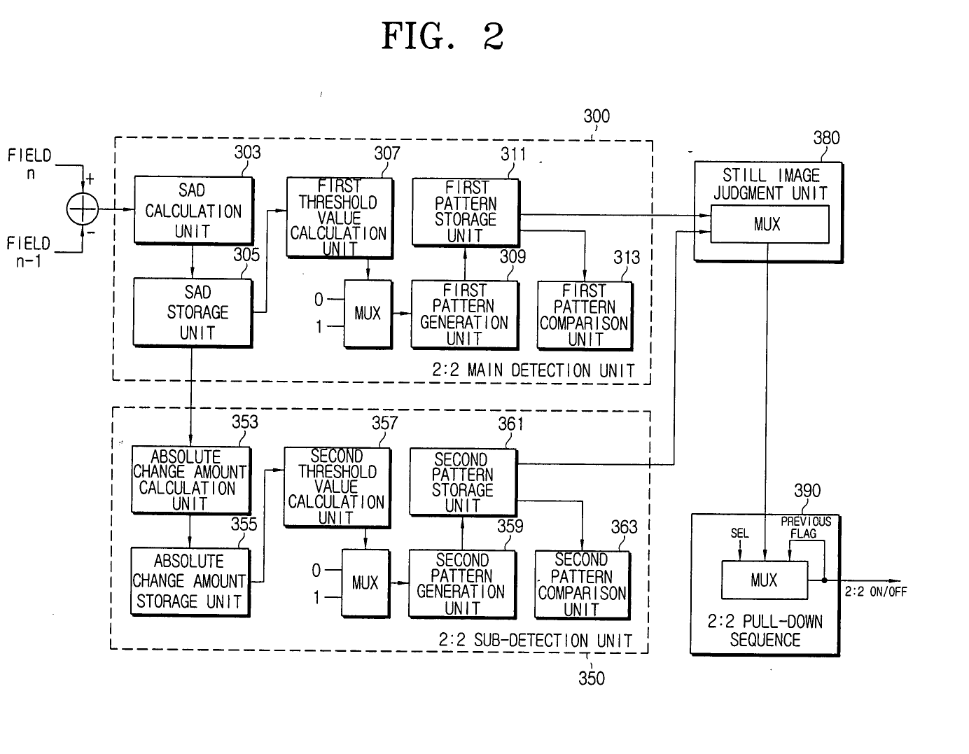

FIG. 2 is a block diagram schematically illustrating an apparatus for detecting a 2:2 pull-down sequence according to the present invention. Referring to FIG. 2, the apparatus for detecting a 2:2 pull-down sequence includes a main detection unit 300, a sub-detection unit 350, a still image judgment unit 380, and a 2:2 pull-down sequence decision unit 390.

The main detection unit 300 calculates a summed absolute difference (SAD) between sequential fields with respect to an input image signal, and detects a 2:2 pull-down image based on the calculated SADs. The sub-detection unit 350 calculates an absolute change amount between the calculated SADs, and detects the 2:2 pull-down image based on the calculated absolute change amounts. The still image judgment unit 380 judges whether the input image signal is a still image based on the calculated SADs and the absolute change amounts. The 2:2 pull-down sequence decision unit 390 decides whether the input image signal is the 2:2 pull-down sequence by combining results of detecting the 2:2 pull-down image by the main detection unit 300 and by the sub-detection unit 350 and a result of judging whether the image signal is the still image by the still image judgment unit 380.

Meanwhile, the main detection unit 300 includes a SAD calculation unit 303, a SAD storage unit 305, a first threshold value calculation unit 307, a first pattern generation unit 309, a first pattern storage unit 311, and a first pattern comparison unit 313.

The SAD calculation unit 303 calculates the SAD between the sequential fields of the image signal. The SAD storage unit 305 sequentially stores the SADs calculated by the SAD calculation unit 303. In order to sequentially store the calculated SADs, the SAD storage unit 305 is implemented by a predetermined number of FIFO (First-In First-Out) buffers. The first threshold value calculation unit 307 calculates a first threshold value using the stored SADs. The first pattern generation unit 309 generates patterns of the SADs according to the calculated first threshold value. The first pattern storage unit 311 sequentially stores the patterns of the SADs generated by the first pattern generation unit 309. In order to sequentially store the SAD patterns generated by the first pattern generation unit 309, the first pattern storage unit 311 is implemented by a predetermined number of FIFO buffers. The first pattern comparison unit 313 compares the pattern of the SAD stored in the first pattern storage unit 311 with a predetermined basic pattern of the SAD.

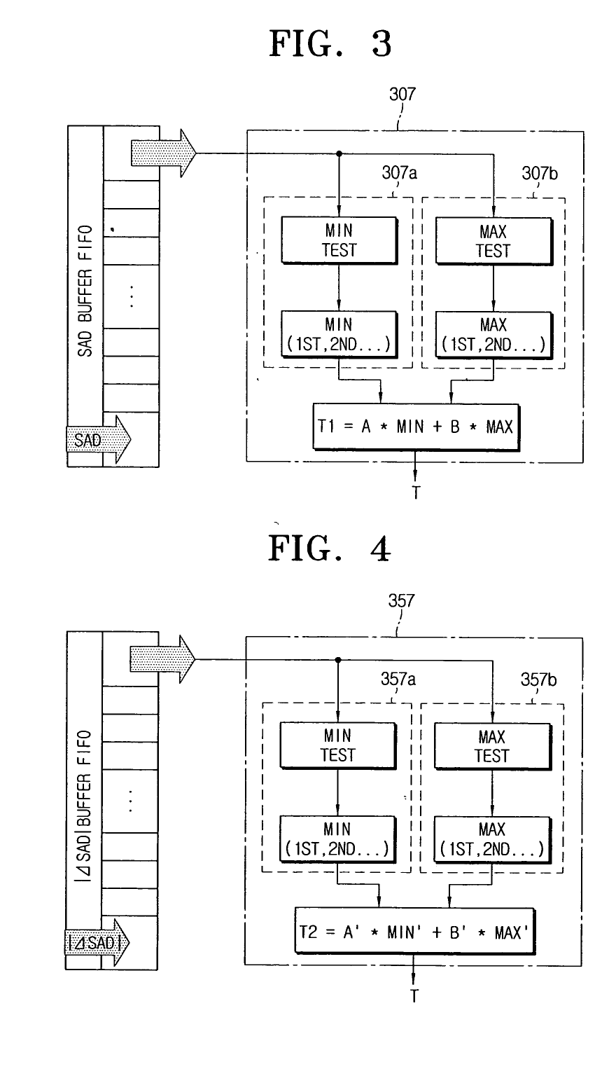

Also, the first threshold value calculation unit 307 includes a first minimum value detection unit 307a and a first maximum value detection unit 307b as shown in FIG. 3. The first minimum value detection unit 307a detects a minimum value of the SADs with respect to a specified section of the SADs stored in the SAD storage unit 305. The first maximum value detection unit 307b detects a maximum value of the SADs with respect to the specified section. In this case, since the 2:2 pull-down sequence has the minimum value of the SADs between two fields of the same frame and has the maximum value of the SADs between sequential fields of two adjacent frames, the first minimum value detection unit 307a and the first maximum value detection unit 307b can be implemented to detect the minimum value and the maximum value with respect to the SADs between the spaced fields. At this time, it is preferable to implement the first minimum value detection unit 307a and the first maximum value detection unit 307b so that the first minimum value detection unit 307a detects the SAD between the fields of the same frame, and the first maximum value detection unit 307b detects the SAD between the fields of the adjacent frames.

Meanwhile, the sub-detection unit 350 includes an absolute change amount calculation unit 353, an absolute change amount storage unit 355, a second threshold value calculation unit 357, a second pattern generation unit 359, a second pattern storage unit 361, and a second pattern comparison unit 363. The absolute change amount calculation unit 353 calculates an absolute change amount between the SADs calculated by the SAD calculation unit 303. The absolute change amount storage unit 355 sequentially stores the calculated absolute change amounts. The second threshold value calculation unit 357 calculates a second threshold value using the stored absolute change amounts. The second pattern generation unit 359 generates a pattern of the absolute change amounts according to the calculated second threshold value. The second pattern storage unit 361 sequentially stores the patterns of the absolute change amounts generated by the second pattern generation unit 359. In this case, it is preferable that the absolute change amount storage unit 355 and the second pattern storage unit 361 are implemented by FIFO buffers in the same manner as the SAD storage unit 305 and the first pattern storage unit 311.

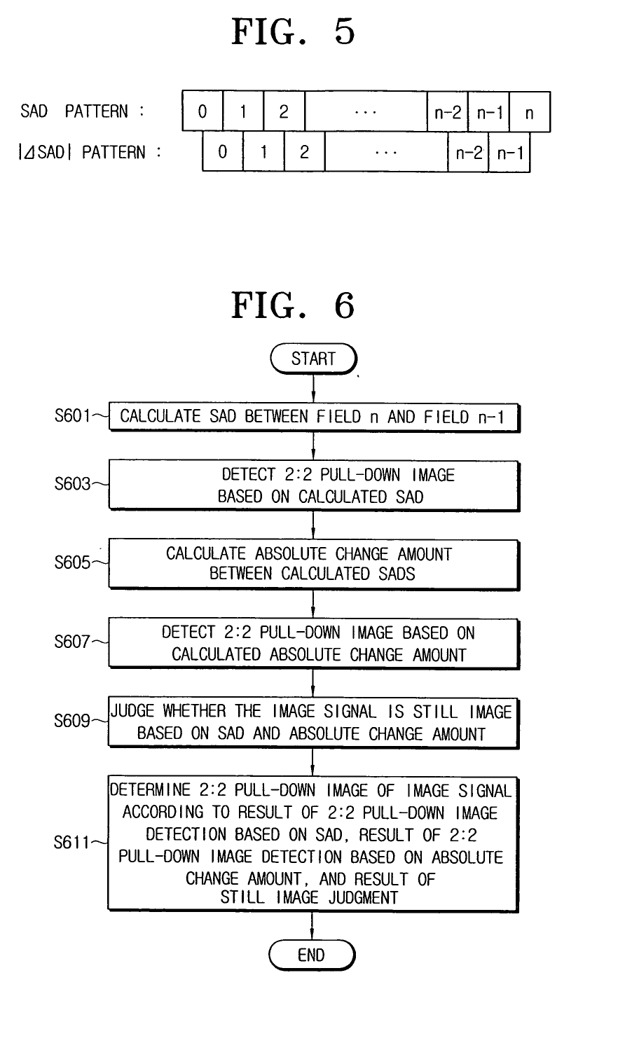

The second pattern comparison unit 363 compares the pattern of the absolute change amount stored in the second pattern storage unit 361 with a predetermined basic pattern of the absolute change amount. Also, the second threshold value calculation unit 357 includes a second minimum value detection unit 357a and a second maximum value detection unit 357b as shown in FIG. 4. The second minimum value detection unit 357a detects a minimum value of the absolute change amounts with respect to a specified section of the absolute change amounts stored in the absolute change amount storage unit 355. The second maximum value detection unit 357b detects a maximum value of the absolute change amounts with respect to the specified section. Here, it is preferable that the second pattern storage unit 361 is implemented so that the absolute change amounts between the SADs stored in the first pattern storage unit 311 are sequentially stored in the second pattern storage unit 361. The relation between the first pattern storage unit 311 and the second pattern storage unit 361 is illustrated in FIG. 5.

FIG. 6 is a flowchart illustrating a method of detecting a 2:2 pull-down sequence performed by the apparatus for detecting a 2:2 pull-down sequence according to the present invention.

Referring to FIG. 6, the SAD calculation unit 303 of the main detection unit 300 calculates the SAD between sequential fields of an input image signal (step S601). That is, if it is defined that the previously inputted field is called a previous field n−1, and a field sequentially following the previous field n−1 is called a present field n with respect to the input image signal, the SAD calculation unit 303 calculates the SAD between the sequential fields by calculating the difference of pixel values between the present field n and the previous field n−1.

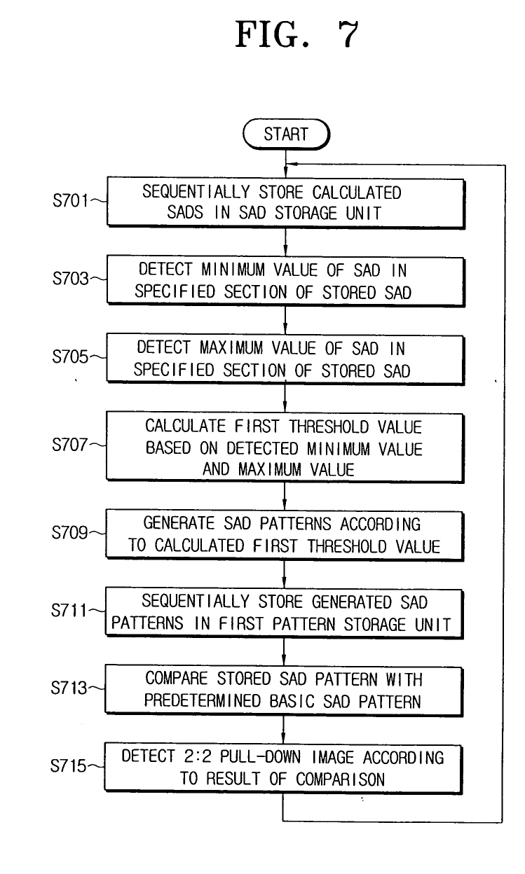

The main detection unit 300 detects whether the input image signal is a 2:2 pull-down image based on the calculated SADs (step S603). The process of detecting a 2:2 pull-down sequence performed by the main detection unit 300 is illustrated in FIG. 7.

Referring to FIG. 7, the SAD storage unit 305 sequentially stores the SADs calculated by the SAD calculation unit 303 (step S701). The first minimum value detection unit 307a of the first threshold value calculation unit 307 detects the minimum value of the SADs with respect to a specified section of the SADs stored in the SAD storage unit 305 (step S703). The first maximum value detection unit 307b of the first threshold value calculation unit 307 detects the maximum value of the SADs with respect to the specified section of the SADs stored in the SAD storage unit 305 (step S705). In this case, since, generally, the SAD between the fields of the same frame has a small value, the first minimum value detection unit 307a may be implemented so as to detect the minimum value by searching for only the SAD between the fields of the same frame once for two periods. Also, since, generally, the SAD between the fields of the adjacent frames is changed, the first maximum value detection unit 307b may be implemented so as to detect the maximum value by searching for only the SAD between the fields of the adjacent frames once for two periods.

The first threshold value calculation unit 307 calculates the first threshold value based on the minimum value and the maximum value of the SADs detected by the first minimum value detection unit 307a and the first maximum value detection unit 307b, and the calculation of the first threshold value is performed by the following equation.
T1=a×MIN+b×MAX [Equation 1]

Here, T1 denotes the first threshold value, a and b are certain values keeping a+b=1, MIN denotes the minimum value of the SADs in a specified section, and MAX denotes the maximum value of the SADs in the specified section.

The first pattern generation unit 309 generates patterns of the SADs stored in the SAD storage unit 305 according to the first threshold value calculated by the first threshold value calculation unit 307 (step S709). In this case, the first pattern generation unit 309 compares the SAD with the first threshold value calculated by the first threshold value calculation unit 307, and generates ‘1’ if the SAD is larger than the first threshold value. Otherwise, the first pattern generation unit 309 generates ‘0’.

The first pattern storage unit 311 sequentially stores the patterns of the SADs generated by the first pattern generation unit 309 (step S711). The first pattern comparison unit 313 compares the pattern of the SAD stored in the first pattern storage unit 311 with the predetermined basic pattern of the SAD (step S713). Here, the basic pattern of the SAD means the basic pattern of the SAD of the 2:2 pull-down image, and appears with two types. That is, the two types of the basic pattern of the SAD are 0101010101 and 1010101010. The main detection unit 300 detects the 2:2 pull-down image according to a result of comparison by the first pattern comparison unit 313 (step S715). This process of detecting the 2:2 pull-down image is repeatedly performed with respect to the input image signal. In the case that the picture is abruptly changed, the 2:2 pull-down image is detected by adaptively changing the threshold value, and thus it can properly cope with the changed picture.

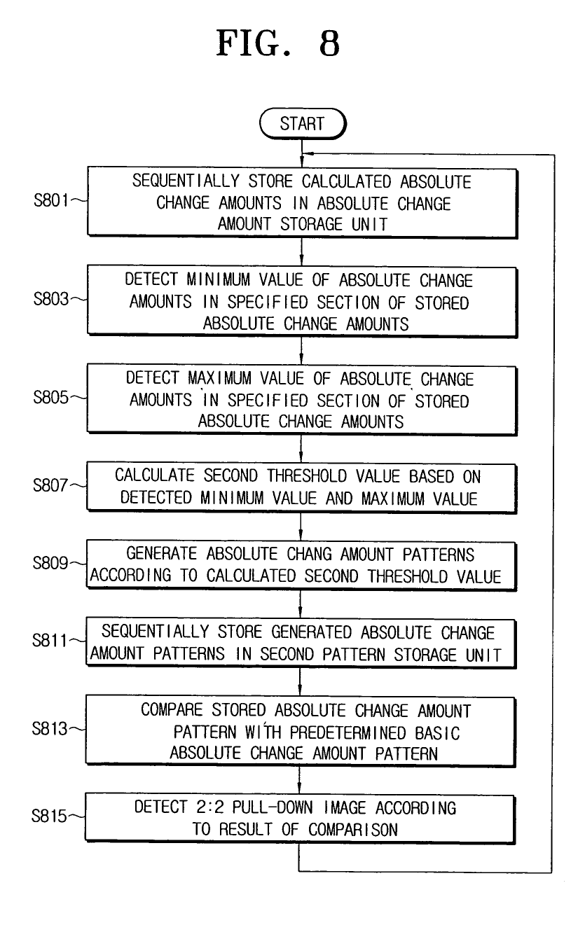

Meanwhile, the absolute change amount calculation unit 353 of the sub-detection unit 350 calculates the absolute change amount between the SADs calculated by the SAD calculation unit 303 (step S605). That is, if it is defined that the difference of pixel values between the previous field n−1 and the present field n is SAD1, and the difference of pixel values between the present field and the next field n+1 is SAD2, the absolute change amount calculation unit 353 calculates the difference of absolute values between SAD1 and SAD2, i.e., the absolute change amount. The sub-detection unit 350 detects whether the input image signal is a 2:2 pull-down image based on the absolute change amounts calculated by the absolute change amount calculation unit 353 (step S607). The process of detecting a 2:2 pull-down sequence performed by the sub-detection unit 350 is illustrated in FIG. 8.

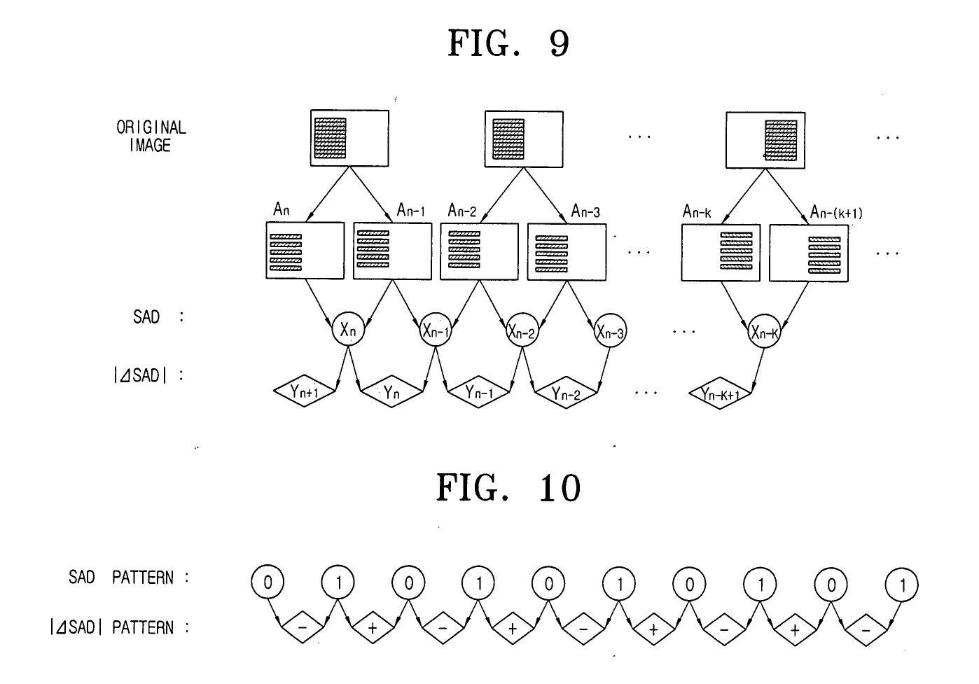

Referring to FIG. 8, the absolute change amount storage unit 355 sequentially stores the absolute change amounts calculated by the absolute change amount calculation unit 353 (step S801). The SAD and absolute change amount in this case are illustrated in FIG. 9. The second minimum value detection unit 357a of the second threshold value calculation unit 357 detects the minimum value of the absolute change amounts with respect to a specified section of the absolute change amounts stored in the absolute change amount storage unit 355 (step S803). The second maximum value detection unit 357b of the second threshold value calculation unit 357 detects the maximum value of the absolute change amounts with respect to the specified section of the absolute change amounts stored in the absolute change amount storage unit 355 (step S805).

The second threshold value calculation unit 357 calculates the second threshold value based on the minimum value and the maximum value of the absolute change amounts detected by the second minimum value detection unit 357a and the second maximum value detection unit 357b, and the calculation of the second threshold value is performed by the following equation.
T2=a′×MIN′+b′×MAX′ [Equation 2]

Here, T2 denotes the second threshold value, a′ and b′ are certain values keeping a′+b′=1, MIN′ denotes the minimum value of the absolute change amounts in a specified section, and MAX′ denotes the maximum value of the absolute change amounts in the specified section.

The second pattern generation unit 359 generates patterns of the absolute change amounts stored in the absolute change amount storage unit 355 according to the second threshold value calculated by the second threshold value calculation unit 357 (step S809). In this case, the second pattern generation unit 359 compares the absolute change amount with the second threshold value calculated by the second threshold value calculation unit 357, and generates ‘1’ if the absolute change amount is larger than the second threshold value. Otherwise, the second pattern generation unit 359 generates ‘0’. In the drawing, ‘+’ is marked instead of ‘1’, and ‘−’ instead of ‘0’.

The second pattern storage unit 361 sequentially stores the patterns of the absolute change amounts generated by the second pattern generation unit 359 (step S811). The second pattern comparison unit 363 compares the pattern of the absolute change amount stored in the second pattern storage unit 361 with the predetermined basic pattern of the absolute change amount (step S813). Here, the basic pattern of the absolute change amount means the basic pattern of the absolute change amount of the 2:2 pull-down image, and appears with two types. That is, the two types of the basic pattern of the absolute change amount are −+−+−+−+−+ and +−+−+−+−+−. The basic pattern of the absolute change amount is illustrated in FIG. 10.

The sub-detection unit 350 detects the 2:2 pull-down image according to a result of comparison by the second pattern comparison unit 363 (step S815).

The still image judgment unit 380 judges whether the input image signal is a still image based on the SAD and the absolute change amount (step S609). For example, if the presently calculated SAD and the SAD calculated before one field are very small in comparison to the previous SAD, and the absolute change amount between the presently calculated SAD and the SAD calculated before one field is very small in comparison to the previous absolute change amount, the present input image is close to a still image. In this case, the pattern of the SAD and the pattern of the absolute change amount stored in the first pattern storage unit 311 and the second pattern storage unit 361 are as follows.
SAD_pattern[n]=0
SAD_pattern[n+1]=0
   |ΔSAD|_pattern[n−1]=0

The 2:2 pull-down sequence decision unit 390 decides whether the input image signal is the 2:2 pull-down sequence by combining results of detecting the 2:2 pull-down image by the main detection unit 300 and by the sub-detection unit 350 and a result of judging whether the image signal is the still image by the still image judgment unit 380. At this time, if it is judged that the input image signal is the still image by the still image judgment unit 380, the present patterns of the SAD and the absolute change amount deviate from the 2:2 pull-down image, but the previous 2:2 pull-down image flag is maintained as it is. Several examples of deciding the 2:2 pull-down sequence by the 2:2 pull-down sequence decision unit 390 are shown in Table 1 below.

TABLE 1

| | Previous | | | | |
|---|---|---|---|---|---|
| Decision | Flag | Still Flag | Main | Sub | Count |
| 0 | 0 | X | 1 | 1 | count < ε |
| 1 | 0 | X | 1 | 1 | count = ε |
| 1 | 1 | 0 | 1 | 1 | X |
| 0 | 1 | 0 | 0 | X | X |
| 1 | 1 | 0 | 1 | 0 | X |
| 1 | 1 | 1 | X | X | X |

The 2:2 pull-down sequence decision unit 390 outputs the 2:2 pull-down image according to the results of detection by the main detection unit 300 and the sub-detection unit 350 and the previous flag. For example, if the previous flag is “0”, and the counted value of the input image signal is smaller than a predetermined value, i.e., if the 2:2 pull-down image detected by the main detection unit 300 and the sub-detection unit 350 does not continue for a predetermined time, the 2:2 pull-down sequence decision unit 390 maintains the previous flag irrespective of the still flag, and outputs “0”. If the main detection unit 300 and the sub-detection unit 350 detect the 2:2 pull-down image in a state that the previous flag is “0” and the counted value of the input image signal reaches the predetermined value, the 2:2 pull-down sequence decision unit 390 reverses the previous flag irrespective of the still flag, and outputs “1”. Here, the fact that the previous flag is “0” means that the 2:2 pull-down image is not decided with respect to the previous image signal.

If the previous flag is “1”, i.e., if the 2:2 pull-down image is decided with respect to the previous image signal, the 2:2 pull-down sequence decision unit 390 decides the 2:2 pull-down sequence irrespective of the counted value. That is, if the 2:2 pull-down image is detected by the main detection unit 300 and the sub-detection unit 350, and the input image is not decided to be the still image by the still image judgment unit 380 in the case that the previous flag is “1”, the 2:2 pull-down sequence decision unit 390 decides that the input image is the 2:2 pull-down sequence. Also, if the still flag is “0”, i.e., if the input image is judged not to be the still image by the still image judgment unit 380, in the case that the 2:2 pull-down image is detected by the main detection unit 300, but the 2:2 pull-down image is not detected by the sub-detection unit 350, the 2:2 pull-down sequence decision unit 390 decides that the input image is the 2:2 pull-down sequence.

However, if the still flag is “1” in the case that the previous flag is “1”, the 2:2 pull-down sequence decision unit 390 maintains the previous flag irrespective of the detection of the 2:2 pull-down sequence by the main detection unit 300 and the sub-detection unit 350, and decides that the input image signal is the 2:2 pull-down sequence. This is for preventing the displayed image from being unnatural due to the frequent on/off operation of the 2:2 pull-down image flag. If the still image that is not the 2:2 pull-down image is inputted after the 2:2 pull-down image signal is inputted, there will not be an ill effect on the displayed image even though the 2:2 pull-down image process is performed with respect to the still image.

Consequently, the apparatus for detecting a 2:2 pull-down sequence according to the present invention can accurately detect the 2:2 pull-down image using the SAD and the absolute change amount. Also, the apparatus can prevent the displayed image from being unnatural by reducing the frequency of on/off operations of the 2:2 pull-down image flag.

As described above, according to the apparatus for detecting a 2:2 pull-down sequence according to the present invention, the 2:2 pull-down image can accurately be detected by the main detection unit and the sub-detection unit and by adaptively coping with the changed picture even in the case of much noise. Also, unnatural display of the image due to the frequent on/off operations of the 2:2 pull-down image flag can be prevented.

While the present invention has been described in detail, it should be understood that various changes, substitutions and alterations can be made hereto without departing from the spirit and scope of the invention as defined by the appended claims.

1. An apparatus for detecting a 2:2 pull-down sequence, comprising:
a main detection unit configured to calculate summed absolute differences (SADs) between sequential fields with respect to an input image signal and detect a 2:2 pull-down image based on the calculated SADs;
a sub-detection unit configured to calculate absolute change amounts between the calculated SADs and detect the 2:2 pull-down image based on the absolute change amounts;
a still image judgment unit configured to judge whether the input image signal is a still image based on the calculated SADs and the absolute change amounts; and
a 2:2 pull-down sequence decision unit configured to decide whether the input image signal is the 2:2 pull-down sequence by combining results of detecting the 2:2 pull-down image by the main detection unit and by the sub-detection unit and a result of judging whether the image signal is the still image by the still image judgment unit.

2. The apparatus as claimed in claim 1, wherein the main detection unit comprises:
a SAD calculation unit configured to calculate the SADs between the sequential fields of the image signal;
a SAD storage unit configured to sequentially store the calculated SADs;
a first threshold value calculation unit configured to calculate a first threshold value using the stored SADs;
a first pattern generation unit configured to generate patterns of the SADs according to the calculated first threshold value;
a first pattern storage unit configured to sequentially store the patterns of the SADs generated by the first pattern generation unit; and
a first pattern comparison unit configured to compare the patterns of the SADs stored in the first pattern storage unit with a predetermined basic pattern of the SADs;
wherein the main detection unit detects the 2:2 pull-down image according to a result of comparison by the first pattern comparison unit.

3. The apparatus as claimed in claim 2, wherein the first threshold value calculation unit comprises:
a first minimum value detection unit configured to detect a minimum value of the SADs with respect to a specified section of the SADs stored in the SAD storage unit; and
a first maximum value detection unit configured to detect a maximum value of the SADs with respect to the specified section;
wherein the first threshold value calculation unit calculates the first threshold value based on the detected minimum and maximum values.

4. The apparatus as claimed in claim 3, wherein the first threshold value calculation unit calculates the first threshold value by the following equation
T1=a×MIN+b×MAX
wherein T1 denotes the first threshold value, a and b are certain values keeping a+b=1, MIN denotes a minimum value of 5 continuous SADs, and MAX denotes a maximum value of the SADs in the specified section.

5. The apparatus as claimed in claim 4, wherein the sub-detection unit comprises:
an absolute change amount calculation unit configured to calculate the absolute change amounts between the calculated SADs;
an absolute change amount storage unit configured to sequentially store the absolute change amounts;
a second threshold value calculation unit configured to calculate a second threshold value using the stored absolute change amounts;
a second pattern generation unit configured to generate patterns of the absolute change amounts according to the calculated second threshold value;
a second pattern storage unit configured to sequentially store the patterns of the absolute change amounts generated by the second pattern generation unit; and
a second pattern comparison unit configured to compare the pattern of the absolute change amounts stored in the second pattern storage unit with a predetermined basic pattern of the absolute change amounts;
wherein the sub-detection unit detects the 2:2 pull-down image according to a result of comparison by the second pattern comparison unit.

6. The apparatus as claimed in claim 5, wherein the second threshold value calculation unit comprises:
a second minimum value detection unit configured to detect a minimum value of the absolute change amounts with respect to a specified section of the absolute change amounts stored in the absolute change amount storage unit; and
a second maximum value detection unit configured to detect a maximum value of the absolute change amounts with respect to the specified section;
wherein the second threshold value calculation unit calculates the second threshold value based on the detected minimum and maximum values.

7. The apparatus as claimed in claim 6, wherein the second threshold value calculation unit calculates the second threshold value by the following equation
T2=a′×MIN′+b′×MAX′
wherein T2 denotes the second threshold value, a′ and b′ are certain values keeping a′+b′=1, MIN′ denotes a minimum value of 5 continuous absolute change amounts, and MAX′ denotes a maximum value of the absolute change amounts of the specified section.

8. The apparatus as claimed in claim 7, wherein the still image judgment unit judges whether the image signal is the still image according to the patterns of the SADs stored in the first pattern storage unit and the patterns of the absolute change amounts stored in the second pattern storage unit.

9. A method for detecting a 2:2 pull-down sequence, comprising:
calculating summed absolute differences (SADs) between sequential fields with respect to an input image signal, and detecting a 2:2 pull-down image based on the calculated SADs;
calculating absolute change amounts between the calculated SADs, and detecting the 2:2 pull-down image based on the absolute change amounts;
judging whether the input image signal is a still image based on the calculated SADs and the absolute change amounts; and
deciding whether the input image signal is the 2:2 pull-down sequence by combining results of detecting the 2:2 pull-down image by the main detection unit and by the sub-detection unit and a result of judging whether the image signal is the still image.

10. The method as claimed in claim 9, wherein the calculating a summed absolute difference comprises:
sequentially storing the calculated SADs in a SAD storage unit;
calculating a first threshold value using the sequentially stored SADs;
generating patterns of the SADs according to the calculated first threshold value;
sequentially storing the generated patterns of the SADs in a first pattern storage unit; and
comparing the stored patterns of the SADs with a predetermined basic pattern of the SADs;
wherein the 2:2 pull-down image is detected according to a result of the SAD pattern comparison.

11. The method as claimed in claim 10, wherein the calculating the first threshold value operation comprises:
detecting a minimum value of the SADs with respect to a specified section of the SADs stored in the SAD storage unit; and
detecting a maximum value of the SADs with respect to the specified section;
wherein the first threshold value is calculated based on the detected minimum and maximum values.

12. The method as claimed in claim 11, wherein the calculating the first threshold value operation calculates the first threshold value by the following equation
T1=a×MIN+b×MAX
wherein T1 denotes the first threshold value, a and b are certain values keeping a+b=1, MIN denotes a minimum value of 5 continuous SADs, and MAX denotes a maximum value of the SADs in the specified section.

13. The method as claimed in claim 12, wherein the calculating an absolute change amount operation comprises:
sequentially storing the absolute change amounts in an absolute change amount storage unit;
calculating a second threshold value using the stored absolute change amounts;
generating patterns of the absolute change amounts according to the calculated second threshold value;
sequentially storing the patterns of the absolute change amounts generated by a second pattern generation unit; and
comparing the patterns of the absolute change amounts stored in a second pattern storage unit with a predetermined basic pattern of the absolute change amounts;
wherein the 2:2 pull-down image is detected according to a result of the patterns of the absolute change amounts comparison.

14. The method as claimed in claim 13, wherein the calculating a second threshold value operation comprises:
detecting a minimum value of the absolute change amounts with respect to a specified section of the absolute change amounts stored in the absolute change amount storage unit; and
detecting a maximum value of the absolute change amounts with respect to the specified section;
wherein the second threshold value is calculated based on the detected minimum and maximum values.

15. The method as claimed in claim 14, wherein the second threshold value calculation step calculates the second threshold value by the following equation
T2=a′×MIN′+b′×MAX′
wherein T2 denotes the second threshold value, a′ and b′ are certain values keeping a′+b′=1, MIN′ denotes a minimum value of 5 continuous absolute change amounts, and MAX′ denotes a maximum value of the absolute change amounts of the specified section.

16. The method as claimed in claim 15, wherein the still image judging operation judges whether the image signal is the still image according to the patterns of the SADs stored in the first pattern storage unit and the patterns of the absolute change amounts stored in the second pattern storage unit.
